(19) United States
(12) Patent Application Publication
(10) Pub. No.: US 2015/0142200 A1
(43) Pub. Date: May 21, 2015

(54) Demand Controller, Charger, and Remote Charging Control System Control Method Using the Same

(71) Applicant: SK Innovation Co., Ltd., Seoul (KR)

(72) Inventors: Jeon Keun Oh, Seoul (KR); Eun Sung Park, Daejeon (KR)

(73) Assignee: SK Innovation Co., Ltd., Seoul (KR)

(21) Appl. No.: 14/404,187

(22) PCT Filed: May 9, 2013
(86) PCT No.: PCT/KR2013/004052

§ 371 Date: Nov. 26, 2014

(30) Foreign Application Priority Data
May 29, 2012 (KR) 10-2012-0056610

(51) Int. Cl. G05F 1/66; G05B 15/02

(52) U.S. Cl. CPC G05F 1/66; G05B 15/02
USPC 700/297

(57) ABSTRACT

Provided are a demand controller, a charger, and a remote charging control system and control method. The remote charging control method includes transferring current power usage from a demand controller to a total operation center (TOC); transferring usable electric energy from the TOC to a remote controller according to current power usage transferred to the TOC; determining whether the remote controller controls the current power usage according to the usable electric energy transferred to the demand controller; as the determination result, when the control of the current power usage is required, transferring a control signal controlling a state-of-charge from the demand controller to a charger or an electric vehicle; and stopping the charging of the electric vehicle according to the control signal transferred to the charger or the electric vehicle.

### TECHNICAL FIELD

The present invention relates to a demand controller, a charger, and a remote charging control system and control method, and more particularly, to a demand controller and a charger capable of reducing peak power, in a time zone in which power consumption is large, by controlling current power consumption using the demand controller and, the charger, and a remote charging control system and control method using the same.

### BACKGROUND ART

Recently, a smart grid test-bed is created and test-operated. A power storing concept among concepts of a smart grid is one of the most important concepts. In this aspect, there is a need to variably use produced power while improving a quality of intermittent and unstable power generated from new renewable energy. However, in order to build the facilities, it is essential to build a new large-scale infrastructure.

Instead of building the large-scale infrastructure, a vehicle to grid (V2G) technology may be used. The V2G technology means that electricity of a battery for an electric vehicle is reversely transmitted to a power grid through a bidirectional charger when a load of a power grid exceeds a peak load. However, in order to perform the V2G technology in the electric vehicle, there is inconvenience that a high-cost bidirectional on-board charger should be essentially mounted in an electric vehicle.

Further, when a load of the power grid exceeds a peak load, that is, when power consumption exceeds peak power production, problems such as blackout occur, which causes a vast social and economic damage. In order to solve the problems, it is essential to build a new large-scale infrastructure. However, the peak power consumption is intensive only at certain times of summer or winter and the power consumption is reduced after the times lapse. Therefore, the built new infrastructure is only operated during a short period of time but is not operated in the remaining period, such that energy production industries need to have large expenditures and exist as non-operated facilities.

### RELATED ART DOCUMENT

### Patent Document

U.S. Pat. No. 08,089,243 (Registration Date: Jan. 3, 2012)

### DISCLOSURE OF INVENTION

### Technical Problem

An object of the present invention is to provide a secondary battery module having a through type cool channel capable of preventing contaminated air generated from battery cells from being introduced into a vehicle and easily cooling heat generated from the battery cells, by sealing an electrode assembly, in which a plurality of battery cells are stacked, by a case, forming a separate gas discharge pipe in the case to discharge the gases to a designated place, and coupling both ends of a partition tube having a cool channel formed therein to contact the battery cells and communicate with an outside of the case.

### Solution to Problem

In one general aspect, there is provided a demand controller including: an information receiving unit that receives information on usable electric energy, according to current power consumption from a total operation center (TOC); a control determination unit that determines whether current power consumption is controlled according to a usable electric energy transferred to the information receiving unit; and a signal transmitting unit that controls a state-of-charge according to whether the control determined by the control determination unit is performed or not.

In another general aspect, there is provided a charger including: a signal receiving unit that receives a control signal controlling the state-of-charge from the outside; a charging interruption unit that interrupts charging of a connected electric vehicle; and a control unit that determines whether the charging interruption unit is operated according to the control signal transferred to the signal receiving unit.

In another general aspect, there is provided a remote charging control system including: a demand controller that receives information on usable electric energy according to current power consumption from a total operation center (TOC), determines whether the current power consumption is controlled based on the information, and transmits a state-of-charge control signal according to the determination; a charger that controls supplied electric energy according to the state-of-charge control signal transferred from the demand controller; and a power demand unit that is connected with the charger and controls charging by a control signal of the demand controller.

In another general aspect, there is provided a remote charging control method including: transferring current power usage from a demand controller to a total operation center (TOC); transferring usable electric energy from the TOC to a remote controller according to current power usage transferred to the TOC; determining whether the remote controller controls the current power usage according to the usable electric energy transferred to the demand controller; as the determination result, when the control of the current power usage is required, transferring a control signal controlling a state-of-charge from the demand controller to a charger or an electric vehicle; and stopping the charging of the electric vehicle according to the control signal transferred to the charger or the electric vehicle.

The demand controller may transfer current power usage to the TOC every a preset time interval.

The remote charging control method may further include: as the determination result, when the control of the current power usage is not required, keeping the charging of the electric vehicle.

### Advantageous Effects of Invention

According to the demand controller, the charger, and the remote charging control system and control method according to the exemplary embodiment of the present invention, it is possible to control the peak power consumption at the time of the generation of the peak load in the power grid by controlling the charging of the electric vehicle mounted with the unidirectional on-board charger (OBC) using the signal generated from the demand charger.

Further, in order for the virtual power plant (VPP) to use power generated from the new renewable energy generation, the energy storage system (ESS) storing power may rapidly cope with the increase in power demand by using the signal generated from the demand controller at the time of the generation of the peak load in the power grid.

### BRIEF DESCRIPTION OF DRAWINGS

The above and other objects, features and advantages of the present invention will become apparent from the following description of preferred embodiments given in conjunction with the accompanying drawings, in which:

FIG. 1 is a diagram schematically illustrating a demand controller according to an exemplary embodiment of the present invention;

FIG. 2 is a diagram schematically illustrating a charger according to an exemplary embodiment of the present invention;

FIG. 3 is a diagram schematically illustrating a remote charging control system according to an exemplary embodiment of the present invention; and

FIG. 4 is a flow chart illustrating a control method of a remote charging control system according to an exemplary embodiment of the present invention.

### DETAILED DESCRIPTION OF MAIN ELEMENTS

10: Demand controller
11: Information receiving unit
12: control determination unit
13: signal transmitting unit
20: charger
21: signal receiving unit]
22: charging interruption unit
23: control unit
30: power demand unit
100: remote charging control system

### BEST MODE FOR CARRYING OUT THE INVENTION

Hereinafter, a demand controller, a charger, and a remote charging control system and control method according to an exemplary embodiment of the present invention will be described in detail with reference to the accompanying drawings. The following introduced exemplary embodiments are, by way of example, provided for sufficiently transmitting an idea of the present invention to those skilled in the art. Therefore, exemplary embodiments of the present invention will not be limited thereto, but may be embodied in other forms. In addition, like reference numerals denote like elements throughout the specification.

Technical terms and scientific terms used in the present specification have the general meaning understood by those skilled in the art to which the present invention pertains unless otherwise defined, and a description for the known function and configuration obscuring the present invention will be omitted in the following description and the accompanying drawings.

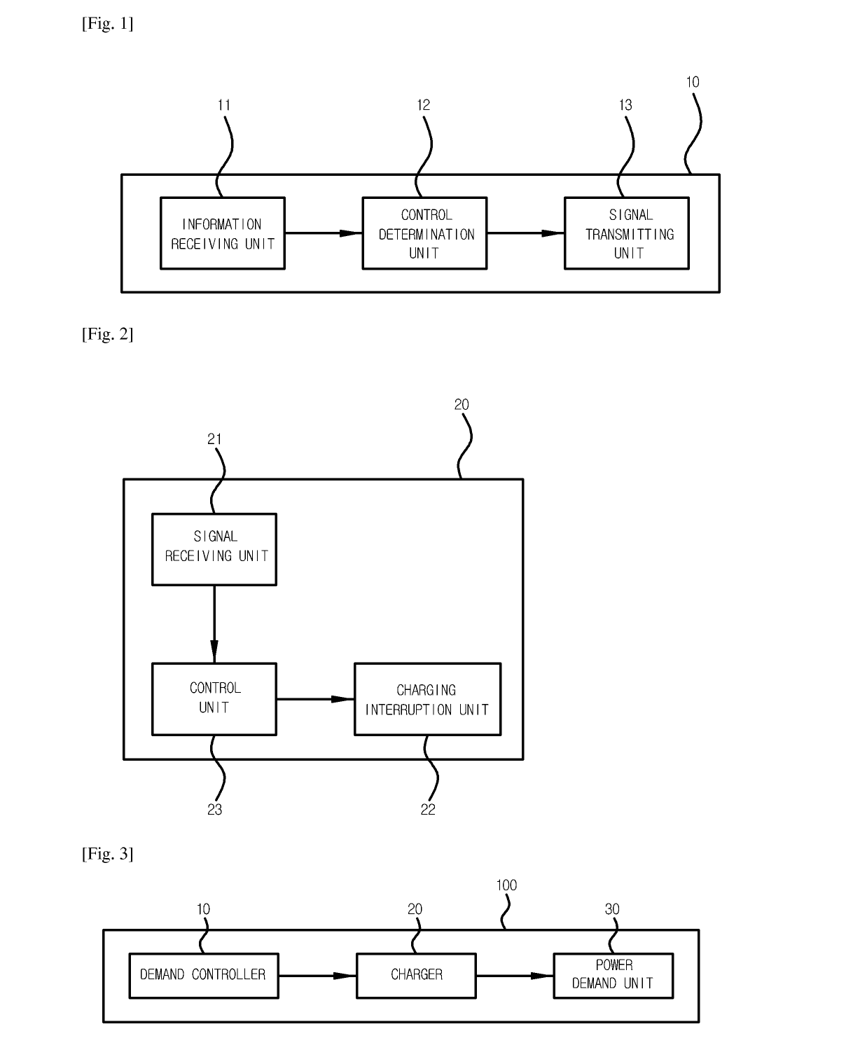

FIG. 1 is a diagram schematically illustrating a configuration of a demand controller according to an exemplary embodiment of the present invention. The configuration of the demand controller according to the exemplary embodiment will be described in detail with reference to FIG. 1.

A demand controller 10 according to an exemplary embodiment of the present invention may include an information receiving unit 11, a control determination unit 12, and a signal transmitting unit 13.

The information receiving unit 11 may receive information on usable electric energy, according to current power consumption from a total operation center (TOC).

The TOC is responsible for managing power generation of a power plant along with a power trading function, that is, wholly responsible for operating a power market and a power grid, and fairly and transparently operates the power market and stably and efficiently operates the power grid.

The TOC may determine the usable electric energy based on a preset threshold value to transfer the determined usable electric energy to the information receiving unit 11 through a dedicated line. In this case, the threshold value may also be changed according to the electric energy produced in the power grid.

The control determination unit 12 may determine whether the current power consumption is controlled according to the usable electric energy transferred to the information receiving unit 10. When extra power is generally indicated 10% less than the peak power production, that is, when the current power consumption consumes 90% or more of the peak power production, the control determination unit 12 determines the control.

The signal transmitting unit 13 may transfer a control signal that controls a state-of-charge according to whether the control determined by the control determination unit 12 is performed or not.

In other words, the demand controller 10 according to the exemplary embodiment of the present invention may be considered as a network operation center (NOC), and may register a power generation resource and a demand resource for demand trading in the TOC to participate in a power market and may also operate the power generation resource and the demand resource, as a power grid. The demand controller 10 may be supplied with power produced from the power grid in the TOC and receive the information on the usable electric energy according to the peak power production from the TOC to transmit a signal for controlling the state-of-charge of the electric vehicle, and the like, that is, a charging stop signal, through the signal transmitting unit 13 according to the usable electric energy, that is, the demand resource.

FIG. 2 is a diagram schematically illustrating a configuration of a charger according to an exemplary embodiment of the present invention. The configuration of the charger according to the exemplary embodiment of the present invention will be described in detail with reference to FIG. 2.

A charger 20 according to an exemplary embodiment of the present invention may include a signal receiving unit 21, a charging interruption unit 22, and a control unit 23.

The signal receiving unit 21 may receive a control signal that controls a state-of-charge from the outside. The charger 20 may receive the charging control signal from the outside through a communication module mounted therein. The charging control signal may be transmitted according to the usable electric energy that may be calculated by comparing the current power consumption with the peak power production. In general, about 10% of the peak power production remains as emergency power and the rest may be calculated as the usable electric energy.

The charging interruption unit 22 may interrupt the charging of the electric vehicle that is connected with the charger 20. The operation of the charging interrupt unit 22 may be controlled in the control unit 23 according to the control signal transmitted to the signal receiving unit 21.

In other words, in the charger 20 according to the exemplary embodiment of the present invention, when the signal receiving unit 21 receives the control signal that controls the state-of-charge from the outside, the control unit 23 performs the operation control associated with the control signal and the charging interruption unit 22 may stop the charging of the electric vehicle connected with the charger 20 according to the control of the control unit 23.

FIG. 3 is a diagram schematically illustrating a configuration of a remote charging control system according to an exemplary embodiment of the present invention. The configuration of the remote charging control system according to the exemplary embodiment will be described in detail with reference to FIG. 3.

The remote charging control system 100 according to the exemplary embodiment of the present invention may include the demand controller 10, the charger 20, and a power demand unit 30.

The demand controller 10 may receive a reduction request of current power consumption from the TOC. In detail, the TOC may use the peak power production to determine the usable electric energy. When it is determined that the current power consumption is larger than the usable electric energy based on the determined usable electric energy, the reduction request of the current electric energy may be transferred to the demand controller 10. The demand controller 10 and the TOC may use the dedicated line to receive the reduction request.

The charger 20 may control the electric energy supplied through the charger 20 according to the reduction request of the current power consumption transferred from the TOC to the demand controller 10. The demand controller 10 may control the charger 20 using the communication line, and in this case, an example of the communication line to be used may include power line communication (PLC), transmission control protocol/internet protocol (TCP/IP), code division multiple access (CDMA), wideband code division multiple access (WCDMA), 3-generation (3G) mobile communication technology, and long term evolution.

The power demand unit 30 is charged by being connected with the charger 20, but may stop the charging according to the reduction request of the current power consumption transferred to the demand controller 10. An example of the power demand unit 30 may include an electric vehicle and an energy storage system (ESS) and an example of the electric vehicle may include an electric vehicle (EV), a hybrid electric vehicle (HEV), a plug-in hybrid electric vehicle (PHEV), a neighborhood electric vehicle (NEV), and the like.

In other words, in order to overcome the peak phenomenon of the power consumption that the current power consumption approximates the threshold value of the peak power production, the power charged in the electric vehicle is retransmitted to the power grid, that is, the TOC by using a vehicle to grid (V2G) technology. However, to this end, there is inconvenience that a high-cost bidirectional on-board charger (OBC), and the like, should be mounted in the electric vehicle.

Therefore, the remote charging control system 100 according to the exemplary embodiment of the present invention provides the reduction request of the current power consumption to the demand controller 10 in order to control the current power consumption when the current power consumption approximates the threshold value of the peak power production in the TOC and the charger 20 may control the electric energy supplied to the power demand unit 30 connected thereto according to the reduction request of the current power consumption transferred to the demand controller 10 connected therewith, that is, may stop the charging of the power demand unit 30.

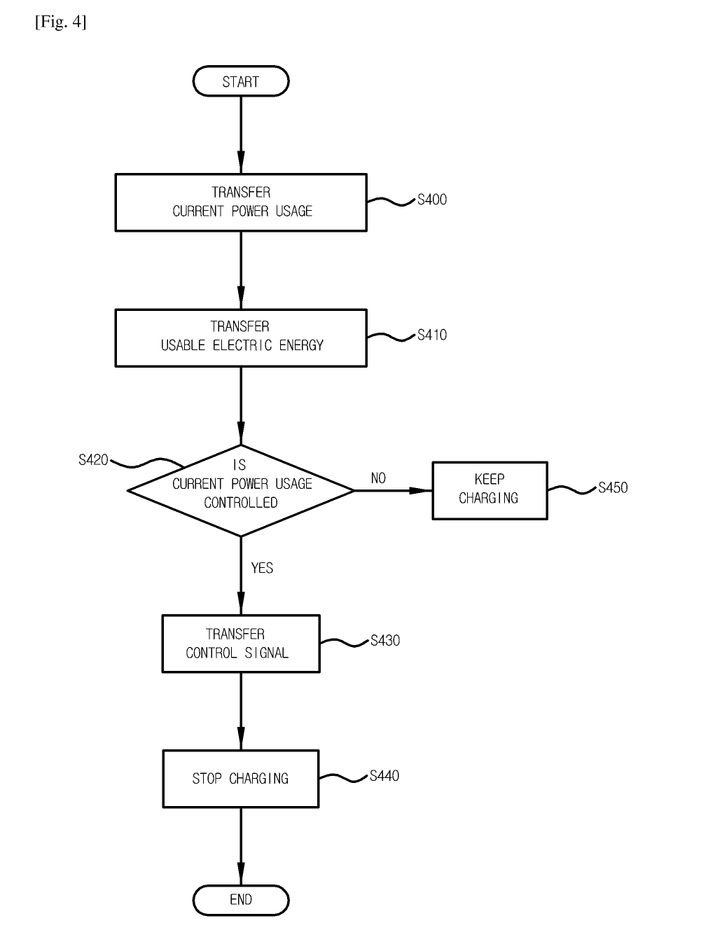

FIG. 4 is a flow chart illustrating a control method of a remote charging control system according to an exemplary embodiment of the present invention. The control method of the remote charging control system according to the exemplary embodiment will be described in detail with reference to FIG. 4.

As illustrated in FIG. 4, the remote charging control method may include transferring the current power usage (S400), transferring the usable electric energy (S410), determining whether the current power usage is controlled (S420), if it is determined that the control is required, transferring the control signal (S430), stopping the charging according to the transferred control signal (S440), and if it is determined that the control is not required, keeping the charging (S450).

In detail, the current power usage may be transferred from the demand controller 10 to the TOC (S400). In this case, the demand controller 10 may transfer the current power usage to the TOC every a preset time interval. The preset time may preferably be about 5 minutes.

The TOC may transfer the usable electric energy to the demand controller 10 according to the received current power usage (S410). In other words, the TOC may receive the current power usage from the demand controller 10 every preset time interval and may use the peak power production and the current power usage to estimate the usable electric energy. The communication between the TOC and the demand controller 10 may be performed through the dedicated line.

The demand controller 10 may determine whether the current power usage is controlled according to the usable electric energy transferred from the TOC (S420). In other words, when the current power usage exceeds the usable electric energy estimated by the TOC, the current power use is immediately controlled and when the current power usage is lower than the usable electric energy estimated by the TOC, the current power use is kept.

As the determination result on whether the current power usage is controlled by the demand controller 10, when the current power usage exceeds the usable electric energy estimated by the TOC or is approximately close thereto, the control signal controlling the state-of-charge may be transferred to the charger 20 or the electric vehicle (S430). In other words, the control signal controlling the state-of-charge may be transferred by a supply equipment communication controller (SECC) or an EV communication controller (EVCC) that is mounted in the charger 20 or the electric vehicle and the EVCC controls the unidirectional OBC through controller area network (CAN) communication with the a battery management system (BMS) that is mounted in the electric vehicle.

In this case, the control of the unidirectional OBC between the EVCC and the battery management system and the battery management system may be performed using the CAN communication. However, since a communication address for the CAN communication is different for each manufacturer of an electric vehicle, there is a problem in that the demand controller 10 needs to transfer the charging control signal, meeting the communication address.

Therefore, the demand controller 10 may transfer the control signal controlling the state-of-charge to the charger 20 or the electric vehicle by using the power line communication PLC, not the CAN communication.

In addition, the demand controller 10 may keep the state-of-charge without generating a particular control signal when the current power usage is lower than the usable electric energy estimated by the TOC, according to the determination result on whether the current power usage is controlled.

In other words, in the demand controller and the charger and the remote charging control system and control method using the same according to the exemplary embodiment of the present invention, the TOC may transfer the information on the usable electric energy according to the current power usage to the demand controller 10 to compare and determine the received usable electric energy with the current power usage, the demand controller 10 may stop the supply of power by generating the control signal to interrupt the charger 20, or may stop the charging through the communication between the electric vehicle and the demand controller 10 when it is determined that the current power usage is required to be controlled.

Therefore, the center, that is, the TOC may reduce the peak power in a time zone in which power consumption is large and may minimize the additional infrastructure building according to the increase in power demand.

Hereinabove, although the present invention is described by specific matters such as concrete components, and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

While the invention has been shown and described with respect to the particular embodiments, it will be understood by those skilled in the art that various changes and modification may be made without departing from the spirit and scope of the invention as defined in the following claims.

1. A demand controller, comprising:
an information receiving unit that receives information on usable electric energy, according to current power consumption from a total operation center (TOC);
a control determination unit that determines whether current power consumption is controlled according to a usable electric energy transferred to the information receiving unit; and
a signal transmitting unit that transmits a control signal controlling a state-of-charge according to whether the control determined by the control determination unit is performed or not.

2. A charger, comprising:
a signal receiving unit that receives a control signal controlling the state-of-charge from the outside;
a charging interruption unit that interrupts charging of a connected electric vehicle; and
a control unit that determines whether the charging interruption unit is operated according to the control signal transferred to the signal receiving unit.

3. A remote charging control system, comprising:
a demand controller that receives information on usable electric energy according to current power consumption from a total operation center (TOC), determines whether the current power consumption is controlled based on the information, and transmits a state-of-charge control signal according to the determination;
a charger that controls electric energy to be supplied according to the state-of-charge control signal transferred from the demand controller; and
a power demand unit that is connected with the charger and controls charging by a control signal of the demand controller.

4. A remote charging control method, comprising:
transferring current power usage from a demand controller to a total operation center (TOC);
transferring usable electric energy from the TOC to a remote controller according to current power usage transferred to the TOC;
determining whether the remote controller controls the current power usage according to the usable electric energy transferred to the demand controller;
as the determination result, when the control of the current power usage is required, transferring a control signal controlling a state-of-charge from the demand controller to a charger or an electric vehicle; and
stopping the charging of the electric vehicle according to the control signal transferred to the charger or the electric vehicle.

5. The remote charging control method of claim 4, wherein the demand controller transfers current power usage to the TOC every a preset time interval.

6. The remote charging control method of claim 4, further comprising:
as the determination result, when the control of the current power usage is not required, keeping the charging of the electric vehicle.
